(19) United States
(12) Patent Application Publication
(10) Pub. No.: US 2012/0104201 A1
(43) Pub. Date: May 3, 2012

(54) BOW HOLDER

(75) Inventors: Ron M. Bean, Cedar Rapids, IA (US); David R. Forbes, Cedar Rapids, IA (US); Maurice Potvin, Newark, OH (US); John I. Brockardt, Marion, IA (US)

(73) Assignee: Hunter's Specialties, Inc., Cedar Rapids, IA (US)

(21) Appl. No.: 13/284,636

(22) Filed: Oct. 28, 2011

Related U.S. Application Data
(60) Provisional application No. 61/408,165, filed on Oct. 29, 2010.

(51) Int. Cl. F41B 5/14; B23P 17/00; B23P 11/00

(52) U.S. Cl. 248/222.14; 248/309.1; 29/525.01; 29/525.11; 29/426.2

(57) ABSTRACT

A bow support for holding an archery bow relative to a support structure is provided. The bow support includes a support structure mount for mounting the bow support to the support structure. The support structure when mounted to the support structure may be removed from the rest of the bow support.

### CROSS-REFERENCE TO RELATED APPLICATIONS

This application claims priority under 35 U.S.C. § 119 to provisional application Ser. No. 61/408,165 filed Oct. 29, 2010, herein incorporated by reference in its entirety.

### FIELD OF THE INVENTION

The present invention relates to a device for supporting an archery bow and more particularly to a bow holder for supporting a bow in a manner which allows quick access to the bow.

### BACKGROUND OF THE INVENTION

While bow hunting, many hunters position themselves where game is likely to pass. While the hunter waits for the game to pass by, it is inconvenient for him to hold an archery bow at the ready. Instead, the hunter may need his hands free in order to perform animal calls or other tasks.

Therefore, it is desirable for the hunter to either rest his bow on the ground or on a support. Various attempts at providing bow supports have been made. Yet problems remain.

### SUMMARY OF THE INVENTION

Therefore, it is a primary object, feature, or advantage of the present invention to provide an improved bow holder.

It is a further object, feature, or advantage of the present invention to provide a bow holder with a hook from which a bow may hang, which allows the hunter to position the hook in a desired position.

It is a further object, feature, or advantage of the present invention to provide a bow holder which may be easily and conveniently attached and detached from a support structure such as a tree.

One or more of these and/or other objects, features, or advantages of the present invention will become apparent from the specification and claims that follow. No single embodiment need exhibit each or every one of these objects, features, or advantages. Different embodiments may achieve different objects, features, or advantages.

According to one aspect of the present invention, a bow support for holding an archery bow relative to a support structure is provided. The bow support includes a support structure mount for mounting the bow support to the support structure, the support structure mount at a first end of the bow support. There is a hook at a second end of the bow support, the second end opposite the first end. There are also a plurality of arms between the support structure and the hook wherein a first of the plurality of arms is connected to the support structure mount and a last of the plurality of arms is connected to the hook and adjacent arms within the plurality of arms are pivotally connected together.

According to another aspect of the present invention, a method to support a bow is provided. The method includes providing a bow support and mounting the bow support to a support structure using a support structure mount.

According to one aspect of the present invention, a bow support for holding an archery bow relative to a support structure is provided. The bow support includes a support structure mount for mounting the bow support to the support structure. The bow support further includes a first arm operatively connected to the support structure mount, a second arm pivotally connected to the first arm, a third arm pivotally connected to the second arm, and a hook pivotally connected relative to the third arm.

### BRIEF DESCRIPTION OF THE DRAWINGS

FIG. 1 illustrates a bow holder where a detachable mounting stud is used to attach the bow holder to a tree.

FIG. 2 illustrates the bow holder in a collapsed position without the anchor support which may be left in a tree.

FIG. 3 illustrates the anchor support and the process of inserting the anchor support into the rest of the bow holder.

FIG. 4 illustrates the bow holder in a collapsed position with the anchor support.

FIG. 5 illustrates the bow holder in an expanded position with the anchor support not attached.

FIG. 6 illustrates the bow holder in a collapsed position with the anchor support attached.

FIG. 7 illustrates an alternative tree mount for the bow holder.

FIG. 8 illustrates a bow holder which uses the alternative tree mount of FIG. 7 and in a collapsed position.

FIG. 9 illustrates the bow holder mounted to a tree using the alternative tree mount of FIG. 7.

FIG. 10 illustrates the bow holder with the alternative tree mount of FIG. 7 and in an expanded position.

FIG. 11 illustrates another bow holder where a detachable mounting stud is used to attach the bow holder to a tree.

FIG. 12 illustrates the bow holder of FIG. 11 in a collapsed position without the anchor support which may be left in a tree.

FIG. 13 illustrates the bow holder in a collapsed position with the anchor support.

FIG. 14 illustrates the bow holder in an expanded position with the anchor support not attached.

FIG. 15 illustrates the bow holder in a collapsed position with the anchor support attached.

FIG. 16 illustrates the bow holder in an expanded position while using the alternative tree mount.

### DETAILED DESCRIPTION

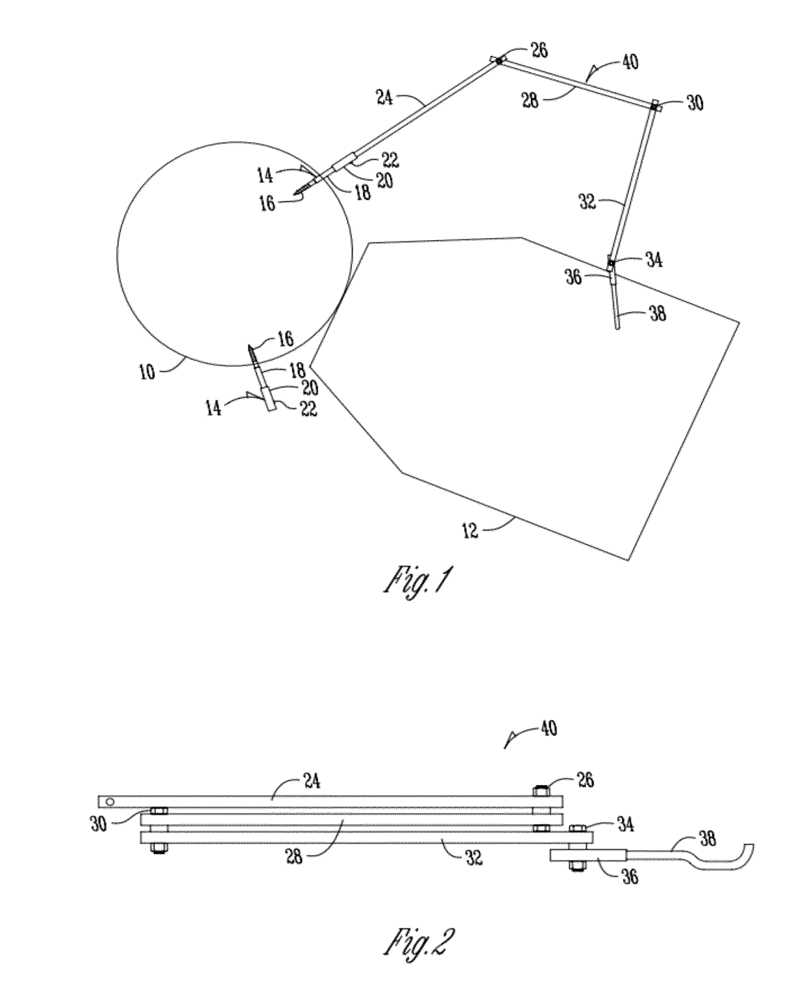

As shown in FIG. 1 a tree 10 is shown along with a tree stand 12 operatively connected to the tree 10 such as a hunter may typically use. Two examples of support structure mounts in the form of anchor supports 14 are shown. Each anchor support 14 has a screw 16 at its tip so that the anchor may be secured to the tree 10. Each anchor support 14 further includes an extension 18 between the screw 16 and a connecting member 20. In one embodiment, the connecting member 20 connects to an arm 24 of the bow support 40 using a button 22. This allows the anchor support 14 to be removably connected with the bow support 40 so that the anchor support 14 may be left in the tree when the hunter is gone.

The bow support 40 further includes a first arm 24 pivotally connected at pivot 26 to a second arm 28. The second arm 28 may be pivotally connected at pivot 30 to a third arm 32. The third arm 32 may be pivotally connected at pivot point 34 to support member 36 from which a hook 38 extends. A bow may be held on hook 38. Because the support member 36 is pivotally connected to the third arm 32, the hunter is able to set the hook 38 so that it is perfectly parallel to the hunter so as to allow the hunter to keep the bow pointing directly at the hunter.

FIG. 2 illustrates the bow holder 40 in a collapsed position without the anchor support which may be left in a tree. Thus, once a hunter secures the anchor support to a tree, they may leave the anchor support at the tree and take the bow holder 40 with them.

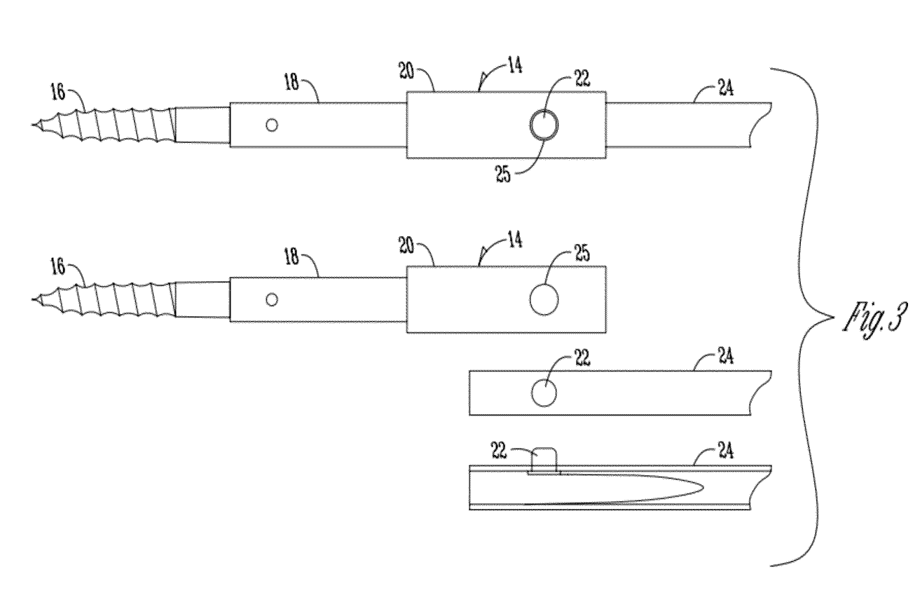

FIG. 3 illustrates the anchor support and the process of inserting the anchor support into the rest of the bow holder. As shown in FIG. 3, a button 22 and buttonhole 25 configuration may be used to secure the anchor support 24 to the first arm 24 of the bow support 40.

FIG. 4 illustrates the bow holder in a collapsed position with the anchor support.

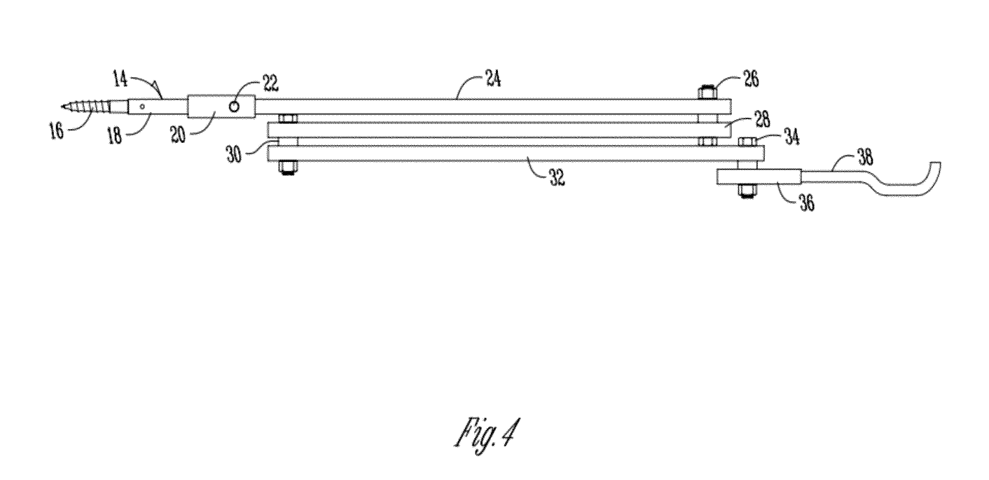

FIG. 5 illustrates the bow holder in an expanded position with the anchor support not attached. Note that the hook 38 of FIG. 5 is of a different shape then the hook of FIG. 4. The present invention contemplates different sizes and shapes for the hook 38. FIG. 6 illustrates the bow holder in a collapsed position with the anchor support attached.

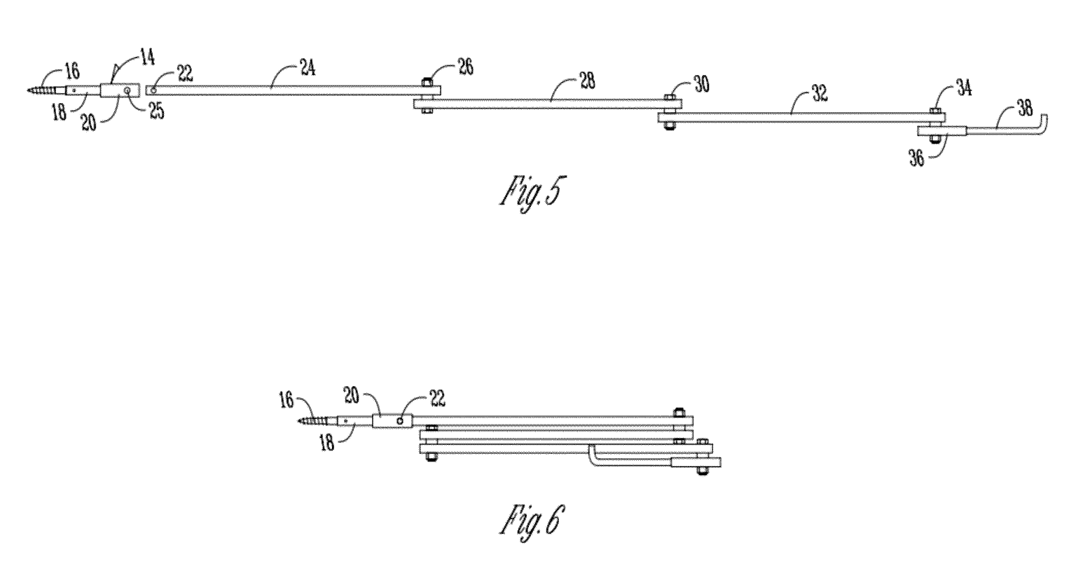

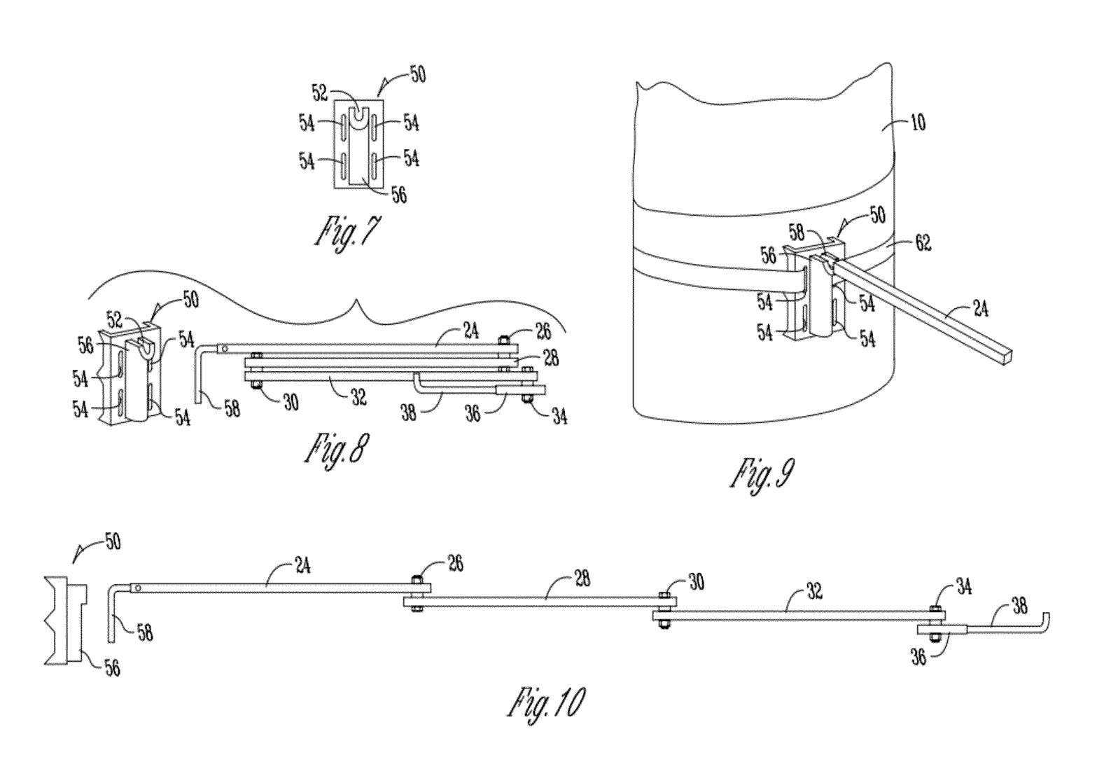

FIG. 7 illustrates an alternative support structure mount for the bow holder. In the alternative of FIG. 7, a tree mount 50 has a plurality of loop holes 54 and a support member 56 with an opening 52. As shown in the system 60 of FIG. 8, a support rod 58 is inserted through the opening 52 into the support member 56 and may then be pressed downward and locked in place. Thus, the bow support may supported by the tree mount 50. FIG. 9 illustrates one example of how the tree mount 50 may be operatively connected to a tree 10 using a belt in the form of a strap, rope, or cable, which is inserted through belt loops 54. FIG. 10 illustrates the bow holder in an expanded configuration where it has not yet been inserted into the tree mount 50.

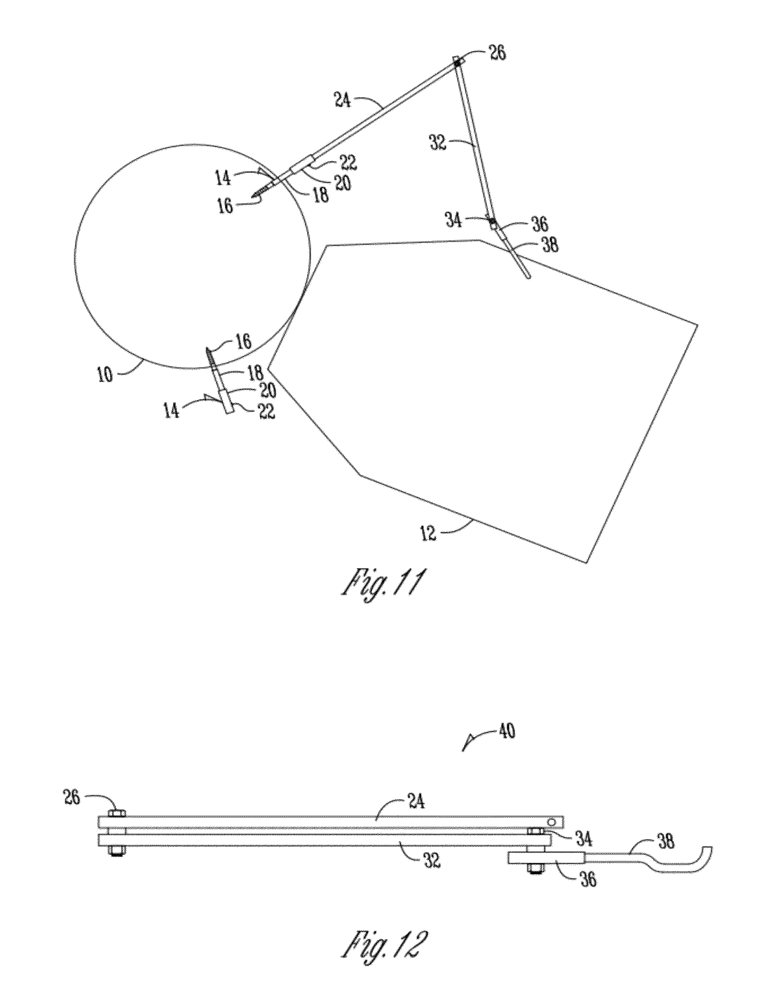

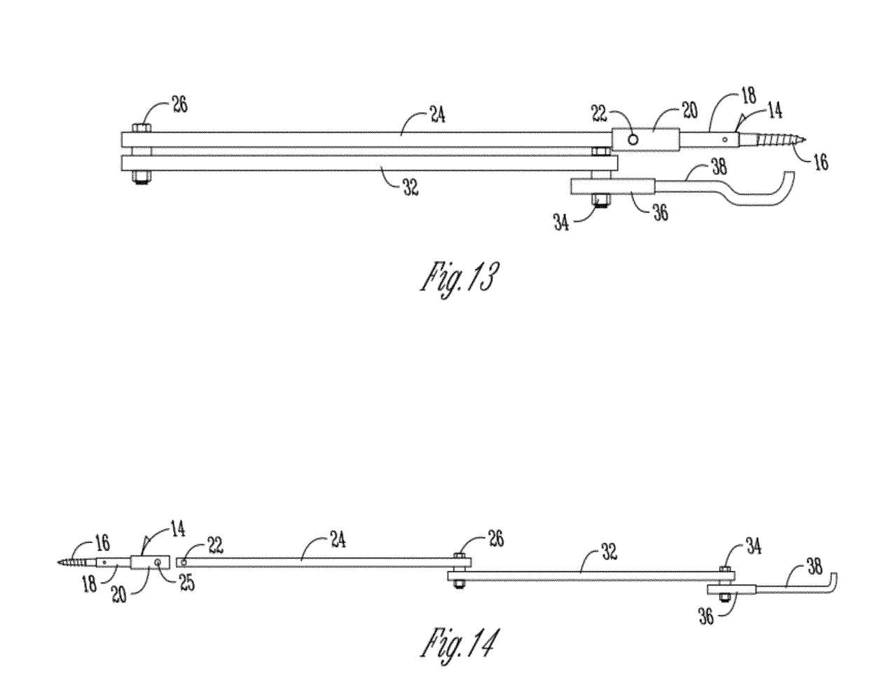

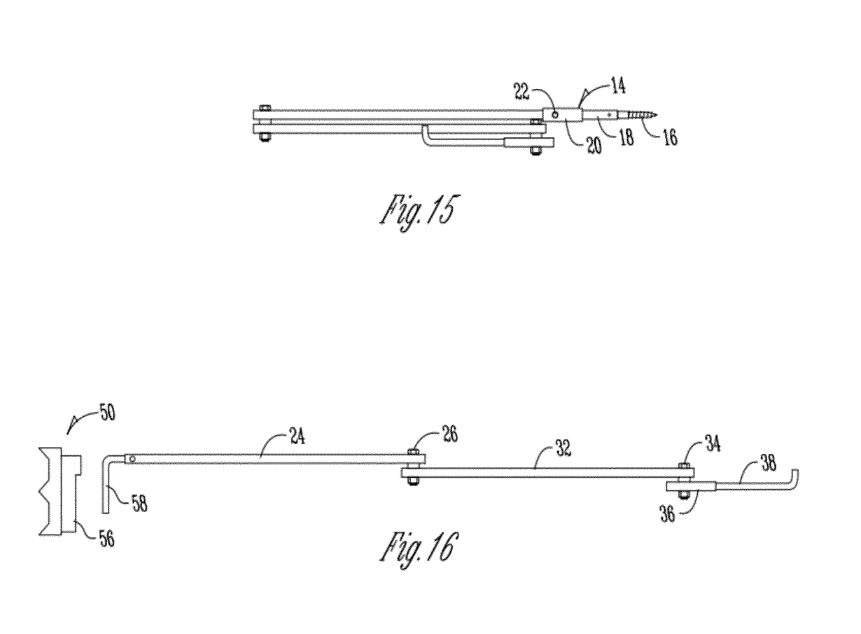

FIG. 11 through FIG. 15 illustrates an alternative embodiment where the bow holder includes fewer arms. The bow holder 14 shown in FIG. 11 through FIG. 15 has the arm 24 of the bow support pivotally connected at pivot point 26 to arm 32. Thus, it is to be understood that the present invention contemplates that a different number of arms may be used.

Instead of the tree mount 50 as shown, the present invention contemplates various alternatives. For example, in the embodiment shown, the tree mount is fixedly connected to the first arm. The tree mount may be rotatably connected to the first arm instead. This may be achieved in various ways, such as by allowing the support rod to rotate freely or by providing teeth or grooves defining a series of positions, similarly a thumbscrew type configuration could be used to connect the tree mount with the first arm in a manner that allows for rotation.

Although various embodiments, variations, options, and alternatives have been discussed, it is to be appreciated that the present invention contemplates differences in structure, materials, sizes, shapes, and geometries. Thus, the present invention is not to be limited to any preferred embodiment discussed herein.

What is claimed:

1. A bow support for holding an archery bow relative to a support structure, the bow support comprising:
a support structure mount for mounting the bow support to the support structure, the support structure mount at a first end of the bow support;
a hook at a second end of the bow support, the second end opposite the first end;
a plurality of arms between the support structure and the hook wherein a first of the plurality of arms is connected to the support structure mount and a last of the plurality of arms is connected to the hook and adjacent arms within the plurality of arms are pivotally connected together.

2. The bow support of claim 1 wherein the support structure mount comprises an anchor support comprising a screw.

3. The bow support of claim 2 wherein the anchor support is removably connected to the first arm.

4. The bow support of claim 3 wherein the anchor support and the first arm are removably connected using a button and a button hole.

5. The bow support of claim 1 wherein the support structure mount comprises a plurality of loop holes and a support member with an opening and wherein a support rod is operatively connected to the first of the plurality of arms, the support rod configured for insertion into the opening of the support member to thereby connect the support structure mount to the first of the arms.

6. The bow support of claim 1 wherein the first of the plurality of arms is rotatably connected to the support structure.

7. The bow support of claim 1 wherein the hook is pivotally connected to the last of the plurality of arms.

8. The bow support of claim 1 wherein the first of the plurality of arms is adjacent the last of the plurality of arms.

9. A bow support for holding an archery bow relative to a support structure, the bow support comprising:
a support structure mount for mounting the bow support to the support structure;
a first arm operatively connected to the support structure mount;
a second arm pivotally connected to the first arm;
a third arm pivotally connected to the second arm;
a hook pivotally connected relative to the third arm.

10. The bow support of claim 9 wherein the support structure mount comprises an anchor support comprising a screw.

11. The bow support of claim 10 wherein the anchor support is removably connected to the first arm.

12. The bow support of claim 11 wherein the anchor support and the first arm are removably connected using a button and a button hole.

13. The bow support of claim 9 wherein the support structure mount comprises a plurality of loop holes and a support member with an opening and wherein a support rod is operatively connected to the first arm, the support rod configured for insertion into the opening of the support member to thereby connect the support structure mount to the first arm.

14. The bow support of claim 9 wherein the first arm is rotatably connected to the support structure.

15. A method to support a bow comprising:
providing a bow support comprising (a) a support structure mount for mounting the bow support to the support structure, the support structure mount at a first end of the bow support; (b) a hook at a second end of the bow support, the second end opposite the first end; and (c) a plurality of arms between the support structure and the hook wherein a first of the plurality of arms is connected to the support structure mount and a last of the plurality of arms is connected to the hook and adjacent arms within the plurality of arms are pivotally connected together; and
mounting the bow support to the support structure using the support structure mount.

16. The method of claim 15 wherein the support structure mount is a screw and the mounting comprises screwing the screw into the support structure.

17. The method of claim 15 further comprising detaching the support structure mount from the bow support and leaving the support structure mount mounted to the support structure.

18. The method of claim 17 further comprising attaching the first of the plurality of arms to the support structure mount while the support structure mount while the support structure mount is mounted to the support structure.
